(19) United States
(12) Patent Application Publication
(10) Pub. No.: US 2024/0033062 A1
(43) Pub. Date: Feb. 1, 2024

(54) DENTAL FLOSS PRODUCT AND METHOD OF MANUFACTURE

(71) Applicant: Genet Kebede Keben, Fredericksburg, VA (US)

(72) Inventor: Genet Kebede Keben, Fredericksburg, VA (US)

(21) Appl. No.: 18/346,831

(22) Filed: Jul. 4, 2023

(30) Foreign Application Priority Data
Feb. 1, 2021 (FI) 20217024
Nov. 24, 2021 (WO) PCT/FI2021/050802

(51) Int. Cl. A61C 15/04

(52) U.S. Cl. CPC A61C 15/041; A61C 15/043

(57) ABSTRACT

The invention relates to a dental floss product and its manufacturing of plate web (2) and dental floss (3). The dental floss product consists of a dental floss (3) comprising an operating part for cleaning tooth gaps and two end portions (1a, 1b) with a gripping surface connected by a joining zone (4c). The ends of the dental floss (3) are permanently fixed around the end portions (1a, 1b) in the same direction of rotation, and the portion of the dental floss (3), which extends around the joining zone (4c) of the end portions (1a, 1b), the opposite direction of rotation. The dental floss (3) is attached to the plate web (2) by rotating dental floss (3) around the end of the plate web (2) back and forth and between rotations moving it step by step forward and cutting it.

The object of the invention is a dental floss product and its method of manufacturing as set out in patent claims 1 and 2 in the preamble.

### BACKGROUND OF THE INVENTION

If the interdental spaces are not cleaned regularly, food and bacteria will accumulate in them, causing gingivitis, cavities, and tartar and plaque formation, among other things. Food left in the gaps can also cause pain. The gaps must therefore be cleaned regularly. Cleaning the interdental spaces does not work well enough with a toothbrush.

here are various products for cleaning the teeth cap. One known solution is toothpicks. Penetration of a toothpick between teeth may also cause momentary pain and possibly also prolonged pain and food may not come out between the molars.

Another known solution is dental floss. The dental floss is usually packed in a package where there are tens of meters into a solid roll inside a plastic case, the case of which is additionally equipped with a cutter. The user can use the cutter to cut the dental floss. One problem is the availability of dental floss when needed. Few carry the entire dental floss package with them. Another problem is cutting the right length of floss with the cutter included in the package. The third problem is holding the slippery dental floss and the caused pain in the fingers around which the dental floss is wound. Another problem with commonly used dental floss is that its case is not biodegradable.

One known solution for cleaning interdental spaces is dental floss product, which is usually plastic and therefore neither biodegradable nor ecological. A further problem with dental floss products is that the dental floss between the arcs is not tensioned tightly enough, making it difficult to get the floss between the teeth. The wire also stretches, and the plastic arch stretches easily. In addition, when the floss slips between the teeth, the ends of the plastic arch often strike the gums or the skin of the cheek, causing pain or, at worst, a wound. In addition, putting a plastic arc in your mouth is not yet pleasant. The child's mouth is also too small for these dental floss products.

There are also known to be interdental brushes for cleaning small interdental spaces, plastic brushes suitable for cleaning large interdental spaces, but especially not for cleaning posterior teeth narrow interdental spaces. In addition, when using an interdental brush, the gums begin to bleed easily. Using an interdental brush can also cause momentary pain as well as prolonged pain. Another problem with interdental brushes is poor ecology.

To clean the interdental spaces, there are also known to be electric interdental jets that spray water through the nozzle into the interdental spaces. The problem with this solution is, among other things, that this cleaning method can be used practically only at home and at the dentist. Another problem is that cleaning between the molars is not possible, at least not easily.

There are also patents and patent applications for dental floss products which have attempted to solve the problem of individually packaged dental floss and the problem of gripping the slippery dental floss. These solutions have been left without practical implementation, for which a convenient solution has now been found.

### BRIEF SUMMARY OF INVENTION

The object of the present invention is to eliminate the above-mentioned drawbacks and to provide an easy-to-use, ecological and inexpensive new type of dental floss product. The method of manufacturing a dental floss product according to the invention is characterized by what is outlined in the characterizing part of claim 1 and the product itself in the characterizing part of claim 2. Other embodiments of the invention are characterized by what is stated in the other claims.

For the dental floss product formed by the manufacturing method according to the invention is characteristic that the product comprises one dental floss comprising an operational part for cleaning tooth gaps and two end pieces with a grip surface connected to the dental floss, the first end piece being fixed to the first end of the dental floss and the second end to the other end of the floss. The area of the gripping surfaces of the end pieces is substantially larger than the gripping area of the dental floss so that it is easy to hold the dental floss product when cleaning the tooth gaps.

Another advantage is that the dental floss can also be hygienically packed in individual packages and the individual products can be conveniently transported so that the dental floss is always available when needed. A further advantage of the dental floss product according to the invention is that the product is simple, environmentally friendly, and inexpensive. In this dental floss product, the slippery generally waxed dental floss is reliably attached to the end portions, and the attachment thus also withstands skewing well. This dental floss product can be made by rotating the dental floss with special arrangements around the plate web forth and back and moving the plate web forward between rotations.

### BRIEF DESCRIPTION OF THE SEVERAL VIEWS OF THE DRAWING

In the following, the invention will be described in more detail with reference to the accompanying simplified drawings, in which

FIG. 1—shows a plate web 2 according to one embodiment of FIG. 3, cut from 1-1,

FIG. 2—shows a plate web 2 according to another embodiment of FIG. 3, cut from 1-1,

FIG. 3—shows one web according to the embodiment of FIG. 5, viewed from above, illustrating the principle of rotation of the dental floss 3 around the plate web 2,

FIG. 3A—shows one coming direction of dental floss 3 and plate web 2 cut from 3A-3A and viewed from the right.

FIG. 3B—shows one other coming direction of dental floss 3 and plate web 2 cut from 3B-3B and viewed from the right.

FIG. 4—shows a manufacturing method for attaching dental floss 3 to a plate web 2 according to one embodiment of FIG. 5, viewed from the side.

FIG. 4A—shows a sectional view (4A-4A) of a manufacturing method for attaching dental floss 3 to a plate web 2 according to one embodiment of FIG. 5, viewed from above as plate web 2 and product web 14 in FIG. 3.

FIG. 5—shows, in the direction of the gripping surfaces, an unpackaged dental floss product after cutting off from product web 14 according to one embodiment of the invention,

FIG. 6—shows the unpackaged dental floss product of FIG. 5 viewed from the left,

FIG. 7—shows, from the direction of the gripping surfaces, a packaged dental floss product before use according to one embodiment of the invention,

FIG. 8—shows a top view of the packaged dental floss product of FIG. 7,

FIG. 9—shows, from the direction of the gripping surfaces, the packaged dental floss product of FIG. 6 for use torn in half,

### DETAILED DESCRIPTION OF THE INVENTION

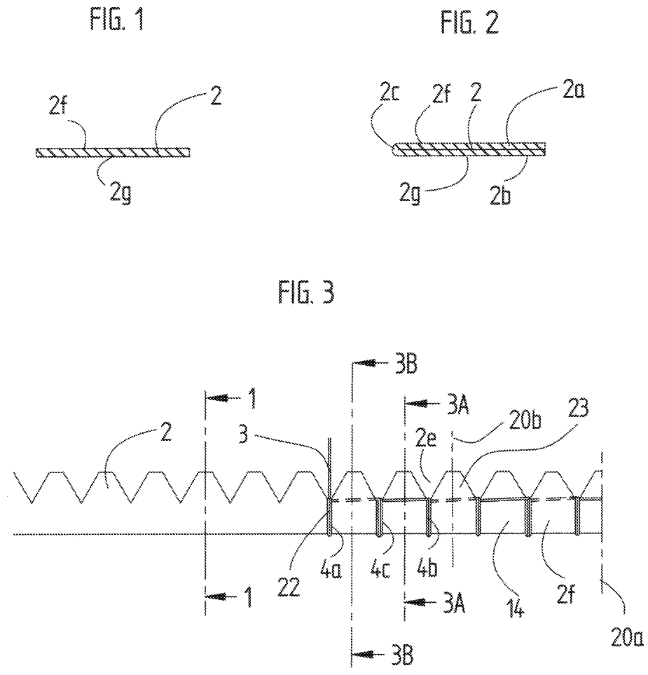

FIG. 1 illustrates a single I-shaped plate web 2, which is thick and strong enough to stand winding dental floss 3 around it. Plate web 2 has two opposite flat sides 2f and 2g.

FIG. 2 illustrates a plate web 2 having thinner plate portions 2a and 2b against each other and joined together by joint 2c. Plate web 2 has two opposite flat sides 2f and 2g.

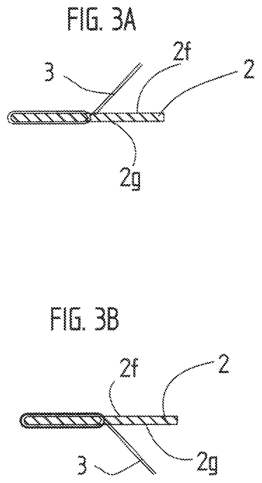

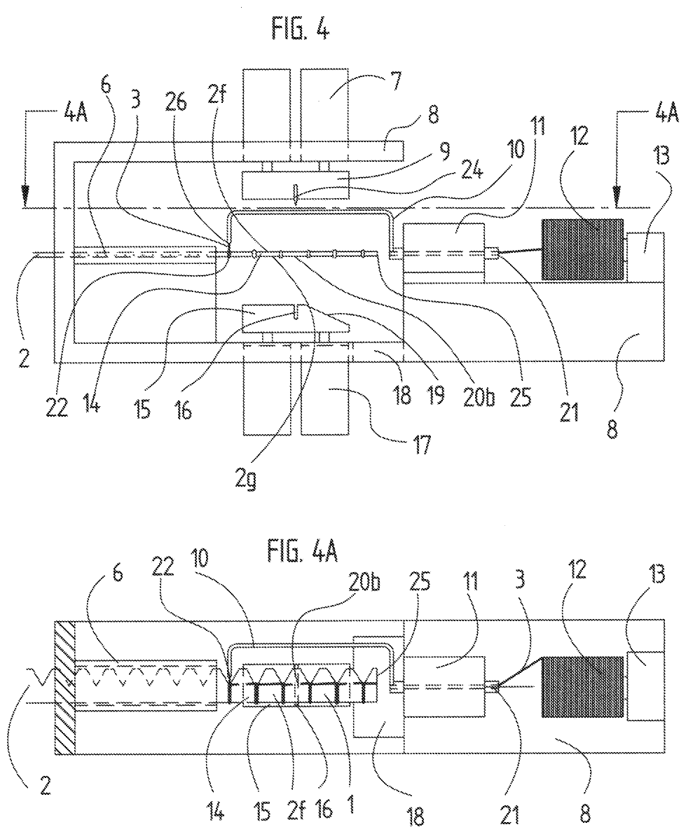

FIG. 3 illustrates how dental floss 3 is rotated around plate web 2 step by step using the manufacturing method described in FIGS. 4 and 4A in which plate web 2 is moving step by step forward from left to right changing into product web 14 having the same flat opposite sides 2f and 2g and including also dental floss 3. Plate web 2 has ready-made notches 2e in which the dental floss 3 will be fixed around plate web 2. There is dental floss 3 on fastening zones 4a and 4b around plate web 2 enough for reliable fixing of dental floss 3 to plate web 2 and on joining zone 4c enough length of dental floss 3 for cleaning tooth gaps. Line 20a shows the place of product web 14 where it has been cut to remove the previous ready unpacked dental floss product from product web 14. Line 20b shows the place between two adjacent fastening zones 4a and 4b where product web 14 will be cut next time to remove the next ready unpacked dental floss product 5 from product web 14. Plate web 2 moves step by step in its longitudinal direction and during its stops dental floss 3 is added on feeding it on line 22 around plate web 2. Lines 3A and 3B help in describing from which directions dental floss 3 comes to plate web 2 in the different production phases. As shown in FIG. 3 installed dental floss 3 is behind the tongue 23 of product web 14 leaning on its flat surface 2g on cutting line 20b. When this tongue 23 of plate web 2 was moving forward on feeding line 22, dental floss was coming to plate web 2 diagonally from below as shown in FIG. 3B passing marked tongue 23. Next plate web 2 was moved more forward and when marked notch 2e reached feeding line 22, dental floss 3 rotated anti-clockwise viewed from the right, guiding dental floss 3 around plate web 2 in notch 2e enough full rounds plus about one-quarter round to avoid sliding of dental floss on fastening zone 4b and when rotation ended to get dental floss 3 to come diagonally from above as illustrated in FIG. 3A. Marked tongue 23 kept dental floss 3 on the bottom level of notch 2e enabling changing the rotation direction of dental floss 3 around plate web 2. Next plate web 2 was moved more forward and when the next notch 2e reached feeding line 22, dental floss 3 started rotating clockwise viewed from the right, guiding dental floss 3 around plate web 2 on joining zone 4c enough full turn plus about one-quarter turn to make operation portion of the dental floss product 1 long enough and to get dental floss 3 to come diagonally from below as illustrated in FIG. 3B. Next plate web 2 was moved more forward and when the next notch 2e reached feeding line 22, dental floss 3 was rotated anti-clockwise viewed from the right, guiding dental floss 3 around plate web 2 until there is enough dental floss 3 on fastening zone 4a and dental floss 3 will come to plate web 2 diagonally from above as illustrated in FIG. 3A. After every forward step of plate web 2, the rotation direction of dental floss 3 around plate web 2 changes and in the same way, changes the side (2f, 2g) on which dental floss 3 is against the flat tongues 23 of product web 14 as illustrated in FIG. 3.

FIG. 4 describes more the method and components which are needed to get dental floss around plate web 2 according to FIG. 3. Plate web 2 is rigid enough for pushing forward by a stepper motor. It feeds step-by-step plate web 2 through guide 6, which is fixed to the body 8. Guide 6 allows plate web 2 to move only in its longitudinal direction. Solenoids 17 are fixed to body 8 and they lift anvil 15 having groove 16 and chamfer 19 until it touches and can support product web 14. Solenoids 7 are fixed to body 8 and they can lower hammer 9 having blade 24 down until it cuts product web 14 on cutting line 20b. The shape and stopping position of pipe 10 allow hammer 9 and anvil 15 to pass it to reach product web 14. After cutting product web 14 unpacked dental floss product 1 drops down utilizing chamfer 19 and hole 18 for further processing. Dental floss 3 is fed from the side of the plate web (2) from the end 26 of feeding pipe 10, which is fixed to hollow shaft 21 of stepper motor 11, fixed to body 8. Stepper motor 11 rotates feeding pipe 10 clockwise and anticlockwise. Feeding pipe 10 is rigid and there is a gap between end 25 of product web 14 and feeding pipe 10 and any rotating part it is fixed to. Feeding pipe 10 comes to feeding line 22 from behind cutting line 20b and end 25 of product web 14 and feeding pipe 10 has free space to rotate around the end of product web 14 up to guide 6. Dental floss roll 12 is fixed to body 8 by support 13. Dental floss 3 goes from roll 12 through shaft 21, pipe 10, and end 26 of pipe 10. When pipe 10 rotates, end 26 of pipe 10 goes through notch 2e on feeding line 22. Plate web 2 is fed step by step through guide 6. Feeding line 22 is close to the edge of guide 6 keeping it in its position during the rotation of dental floss 2 around plate web 2. Both FIGS. 3 and 4 illustrate the moment just before cutting product web 14. It happens after every third step on cutting line 20b between adjacent fastening zones 4a and 4b. In this solution, we can freely select the number of revolutions on joining zone 4c and fastening zones 4a, and 4b because the feeding of dental floss 3 around plate web 2 takes place around the end 25 of product web 14. If adding dental floss 3 around plate web 2 took place around endless plate web 2 by twisting it back and forth and it has its limits. Number of revolutions on joining zone 4c and fastening zones 4a and 4b need to be equal or follow the rule 4a+4b=4c, in which 4a, 4b, and 4c are integers of revolutions on corresponding zones to avoid breaking of the plate web 2 by twisting.

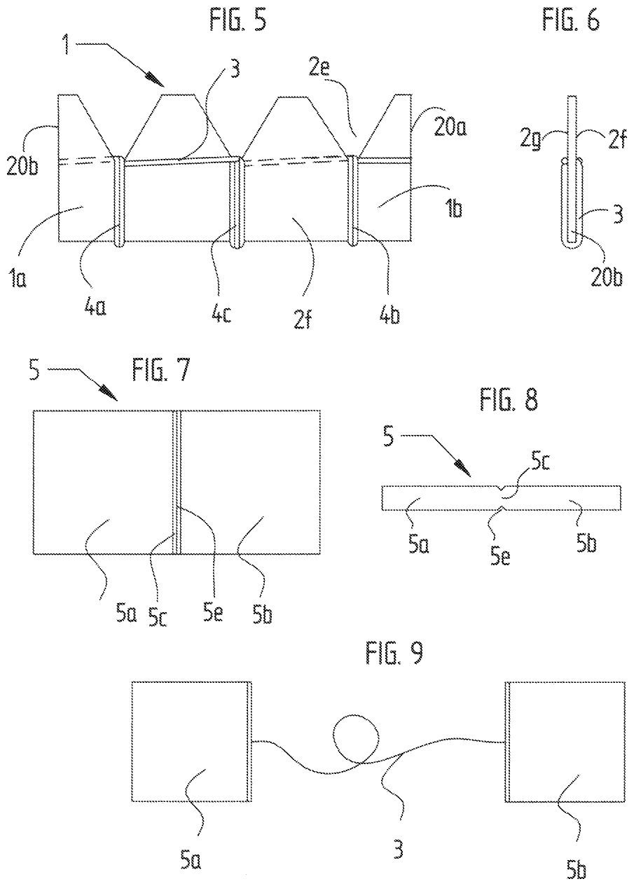

FIG. 5 shows an unpackaged dental floss product 1 according to one embodiment of the invention before the end portions 1a and 1b are separated from each other. This product consists of dental floss 3 and plate 1, which has two opposite sides 2f and 2g. Dental floss 3 comes from previous notch 2e to notch 2e on one side 2f of plate 1 and continues forward to next notch 2e on the other side 2g of plate 1. This dental floss product comprises dental floss 3 and plate-like end portions 1a and 1b which are connected by a joining zone 4c. The plate-like end portions are made of, for example, recyclable, and biodegradable cardboard or carton, and the dental floss is candelilla waxed natural silk. The length of the dental floss product is substantially twice its width and the joining zone 4c is substantially longitudinally from the center of the product. In this application example, the tear line is implemented, for example, by cutting, grooving, or perforating, but leaving the bottoms of the notches 2e intact in the joining zone for the rotation of the dental floss 3. The plate-like dental floss product can be easily cut into two separate parts at the joining zone 4c. Dental floss 3 is attached to the fastening zones 4a and 4b of the end portions 1a and 1b, and the dental floss operational portion is stored in the joining zone 4c. Dental floss 3 goes from fastening zone 4a on the front side of the end portion 1a and dental floss 3 goes from join-ing zone 4c on the back side of the end portion 1b. The dental floss 3 is preferably fixed in the middle of the end portions 1a and 1b, using cuts as shown in the figure up to the middle of the end portions 1a and 1b. The cut may, of course, be a groove or the like and there may be a hole in the bottom of the cut through which the dental floss 3 passes through the end portion. Cut edges 20a and 20b show the places in which the dental floss products are cut apart from each other between adjacent fastening zones 4a and 4b.

FIG. 6 shows the unpackaged dental floss product of FIG. 5 viewed from the left showing the cut dental floss 3 installed around plate 1.

FIGS. 7 and 8 show a packaged dental floss product according to one embodiment of the invention before use. The dental floss product comprises protective package 5 and, inside it, shielded portions 1a and 1b detached from product web 14, which are connected by the joining zone 4c below the splicing zone 5c. The packaged dental floss product is divided into two end portions 5a and 5b. Protective package 5 and plate web 2, which are permanently attached, for example by gluing, are made of, for example, recyclable and biodegradable cardboard or carton, if desired moisture-resistant sheet-like and substantially rectangular. A piece of dental floss is tightly and hygienically packed inside the package. The length of the dental floss product is substantially twice its width, and the dental floss product is divided into two end portions 5a and 5b substantially longitudinally from the center of the package to which a splicing zone 5c is made, which in this embodiment is a tear line by mutual creasing. The plate-like dental floss product can be easily cut into two separate parts at the splicing zone 5c also by using crease 5c and notch 2e in plate web 2 below. The plate-like package may contain, for example, the name of the hotel chain in the bathroom of the hotel room or information about the product. The size of the package is 5-30 mm×10-60 mm preferably 15-20 mm×30-40 mm. The package may have information about the product and/or the color of the package or the number on it may indicate the thickness of the dental floss or the like. Also, the shape and size of protective package 5 can be different from those shown in FIGS. 6 and 7. Shapes of animals and cartoon characters can be used in plate-like packages or protective package 5 can be other than plate-like e.g. a relief or 3D figure when molding, casting, or a similar method is used in the manufacturing of protective package 5.

FIG. 9 shows the dental floss product of FIG. 7 cut in half. The dental floss product is divided into two separate plate-like end portions 5a and 5b, i.e. the gripping portion or the holding member, by tearing the dental floss product open at the splicing zone 5c, i.e. the tear line. When the dental floss product is divided in this way into two end portions 5a and 5b and the end portions are pulled apart, the operational portion of the dental floss 3 is packed therein, with which the tooth gaps are to be cleaned, emerges. The dental floss 3 is further attached at its ends to the end portions 5a and 5b provided with gripping surfaces having an area substantially larger than the gripping area of the dental floss 3. The dental floss product is now in its operating state, in which the product has two spaced-apart end portions 5a and 5b, between which there is a dental floss 3 operating portion with which the user can clean his interdental spaces. When the user cleans his tooth gaps with dental floss 3, he holds on to the end portions 5a and 5b, whereby the cleaning of the tooth gaps is successful and easy without the problems described in the general part of the application. It is easy to hold the end parts 5a and 5b and the tensioning of the dental floss 3, i.e. the adjustment of the tension to suit, is also easy and requires less compressive force than, for example, when using ordinary dental floss. Both end portions 5a and 5b are held, for example, with fingers and/or palms. In this case, the grip of the end parts 5a and 5b is a compression grip caused by fingers and/or the palm. The gripping surface, i.e. the gripping area of the end portions 5a and 5b, is substantially larger than the gripping surface when using conventional dental floss. Dental floss 3 is also easy to fit in the tooth gaps. The end portions 5a and 5b, i.e. the holding members or at least one of them, may also be coated with mate-rial allowing good adhesion, preferably with a material with good friction, or the surface may be loose and/or the surface may have bumps or the like so that the holding member slips less when in hand.

In this solution, we can freely select the number of revolutions on joining zone 4c and fastening zones 4a, and 4b because the feeding of dental floss 3 around plate web 2 takes place around the end of product web 14. If feeding took place around endless plate web 2 the number of revolutions of dental floss 3 around plate web 2 should need to be the same on joining zone 4c and fastening zones 4a and 4b, or follow the rule 4a+4b=4c, in which 4a, 4b and 4c are integers of revolutions on corresponding zones to avoid twisting.

FIGS. 1, 2, and 3 show and have described above a preferred embodiment of the invention in which the dental floss product is unpackaged.

By reciprocating plate web 2 illustrated in FIG. 2 can also be used in the other position cutting notches 2e on joint 2c end.

In one preferred embodiment pipe 10 is not fixed to shaft 21 in the rotation center of stepper motor 11 but goes somewhere else through a rotating part.

It is also clear to a person skilled in the art that feeding pipe can be shorter and some other type of around plate web 2 rotating part fixed to feeding pipe 10 guides dental floss 3 to come from behind the cutting line (20b) and the end 25 of the product web 14.

It is also clear to a person skilled in the art that feeding pipe can be of some other type of around plate web 2 rotating part guiding dental floss 3 to come from behind the cutting line (20b) and the end 25 of the product web 14.

It is also clear to a person skilled in the art that instead of solenoids 7 and 17 some other actuators can be used.

It is also clear to a person skilled in the art that instead of a crease on the protective package 5 also a low perforation or a small cut through the protective package 5 on the side of notch 2e can be used.

1. Method of manufacturing a dental floss product comprising a single dental floss (3), its feeding pipe (10) having an end (26), two opposite sides (2f, 2g), forming the plate web (2) comprising notches (2e), around which the dental floss (3) is placed step by step by feeding the dental floss (3) on the feeding line (22) through the end (26) of feeding pipe (10) from the side of the plate web (2) by rotating the feeding pipe (10) around the plate web (2) back and forth in the direction of the longitudinal axis of plate web (2), and between the rotations by moving the plate web (2) characteristically in the direction of its longitudinal axis changing the plate web (2) supported by a guide (6) into a product web (14) having an end (25), characterized in that the feeding pipe (10) rotating around the product web (14) guides dental floss (3) to come to the notch (2e) of the plate web (2) on the feeding line (22) from behind the end (25) of the product web (14).

2. A dental floss product comprising a single dental floss (3), end portions (1a, 1b), two opposite sides (2f, 2g), cut edges (20a, 20b) forming the plate (1) comprising fastening zones (4a, 4b), joining zone (4c) and notches (2e), around which the dental floss (3) is placed characterized in that the dental floss (3) comes from the first notch (2e) to the second notch (2e) on one side (2f) of the plate (1) and continues forward to the third notch (2e) on the other side (2g) of the plate (1).

3. A method of manufacturing a dental floss product according to claim 1, characterized in that the end 26 of feeding pipe 10 starts each rotation on one side (2f) of the plate web (2) and ends rotation on the other side (2g) of the plate web (2).

4. A method of manufacturing a dental floss product according to claim 1, characterized in that feeding pipe 10 has free space to rotate around the product web 14 up to the guide (6) of the plate web (2).

5. A method of manufacturing a dental floss product according to claim 1, characterized in that the shape and the stopping position of the feeding pipe (10) allow the hammer (9) and the anvil (15) to pass it to cut the product web (14).

6. A method of manufacturing a dental floss product according to claim 1, characterized in that the joining zone (4c) can have 7 rounds and both fastening zones (4a, 4b) 3 rounds of dental floss (3).

7. A method of manufacturing a dental floss product according to claim 1, characterized in that the manufacturing method does not limit the selection of the number of the dental floss (3) turns around the plate web (2) on joining zone (4c) and fastening zones (4a, 4b).

8. A method of manufacturing a dental floss product according to claim 1, characterized in that the plate web (2) is supported by the guide (6), which allows the plate web (2) to move only in the direction of its longitudinal axis.

9. A method of manufacturing a dental floss product according to claim 1, characterized in that the end (26) of the rotating feeding pipe (10) goes through the notch (2e) on the feeding line (22).

10. A method of manufacturing a dental floss product according to claim 1, characterized in that the end (26) of the feeding pipe (10) rotates each time in one direction around the plate web (2) about one-quarter round over the final number of full turns the dental floss (3) stays around the plate web (2).

11. A method of manufacturing a dental floss product according to claim 1, characterized in that at least on one side of the protective package (5) a crease (5e) is made to facilitate tearing in half.

12. A method of manufacturing a dental floss product according to claim 1, characterized in that the manufacturing process comprises immersion of the dental floss (3) into the product web (14) and/or protective package (5) at least in part.

13. A dental floss product according to claim 2, characterized in that the dental floss (3) rotates around the plate (1) on the fastening zones (4a, 4b) of the plate (1) less than on the joining zone (4c) of the plate (1).

14. A dental floss product according to claim 2, characterized in that the rotation direction of the dental floss (3) around the plate (1) on the joining zone (4c) is different from the rotation direction of the dental floss (3) around the plate (1) on fastening zones (4a, 4b).

15. A dental floss product according to claim 2, characterized in that at least on one side of the protective package (5) there is a crease (5e) on the joining zone (4c) to facilitate tearing in half.

16. A dental floss product according to claim 2, characterized in that protective package (5) contains information about the dental floss product, such as the thickness of the dental floss (3) contained in the product or other information provided by the manufacturer.

17. A dental floss product according to claim 2, characterized in that at least one of the surfaces of the protective package (5) is rough and/or has protrusions.

18. A dental floss product according to claim 2, characterized on that the joining zone (4c) of the plate (1) stores an operational part of the dental floss (3), of 5-25 cm, preferably 7-13 cm.

19. A dental floss product according to claim 2, characterized in that the size of the protective package (5) in which the unpacked dental product is packaged is 8-33 mm×13-63 mm preferably 16-23 mm×33-43 mm.

20. A dental floss product according to claim 2, characterized in that the shape of the protective package (5) in which the unpacked dental product is packaged, is a relief or a 3D figure.
